(19) United States
(12) Patent Application Publication
(10) Pub. No.: US 2024/0020739 A1
(43) Pub. Date: Jan. 18, 2024

(54) SERVER

(71) Applicant: TOYOTA JIDOSHA KABUSHIKI KAISHA, Toyota-shi Aichi-ken (JP)

(72) Inventor: Kyohei MASUI, Edogawa-ku Tokyo-to (JP)

(73) Assignee: TOYOTA JIDOSHA KABUSHIKI KAISHA, Toyota-shi Aichi-ken (JP)

(21) Appl. No.: 18/219,964

(22) Filed: Jul. 10, 2023

(30) Foreign Application Priority Data
Jul. 15, 2022 (JP) 2022-114331

(51) Int. Cl. G06Q 30/04; G06Q 30/0601; G06Q 20/10

(52) U.S. Cl. CPC G06Q 30/04; G06Q 30/0641; G06Q 20/102

(57) ABSTRACT

A server includes an acquisition unit configured to acquire arrangement information related to a layout of a component disposed in a vehicle cabin space other than a seat for travel in a vehicle, the arrangement information being determined by a user wishing to use the vehicle, and a presentation unit configured to present, to the user, plural contract formats related to payment in relation to provision of the vehicle in which the component is disposed in the vehicle cabin space in accordance with the arrangement information acquired by the acquisition unit or of the component according to the arrangement information.

### CROSS-REFERENCE TO RELATED APPLICATION

This application is based on and claims priority under 35 USC § 119 from Japanese Patent Application No. 2022-114331 filed on Jul. 15, 2022, the disclosure of which is incorporated by reference herein.

### TECHNICAL FIELD

The present disclosure relates to a server.

### RELATED ART

Japanese Patent Application Laid-Open No. 2019-164477 (Patent Document 1) discloses a technique in which, in a case of providing information, the information to be provided is selected in accordance with the presence of a user who perceives the information, and provision of the information is performed appropriately.

The technology of Patent Document 1 only assumes providing appropriate information in a vehicle cabin, and does not consider how the interior of the vehicle cabin space will be configured by a user. Since the usage requirements for a vehicle or components placed in a vehicle having an interior that has been configured in advance vary depending on the user, there is a need to provide payment methods relating to the provision of vehicles or components that meet the usage requirements.

### SUMMARY

Accordingly, an object of the present disclosure is to provide a server that enables payment, relating to the provision of a vehicle or a component placed in the vehicle that reflects an interior configured in advance by a user, to be performed by a method that meets the user's needs.

A server according to a first aspect includes an acquisition unit configured to acquire arrangement information related to a layout of a component disposed in a vehicle cabin space other than a seat for travel in a vehicle, the arrangement information being determined by a user wishing to use the vehicle; and a presentation unit configured to present, to the user, plural contract formats related to payment in relation to provision of the vehicle in which the component is disposed in the vehicle cabin space in accordance with the arrangement information acquired by the acquisition unit or of the component according to the arrangement information.

In the server according to the first aspect, an acquisition unit acquires arrangement information. Moreover, a presentation unit presents, to the user, plural contract formats relating to payment relating to provision of a vehicle in which a component is arranged in a vehicle cabin space in accordance with the arrangement information acquired by the acquisition unit or of a component according to the arrangement information. In this way, with the server, by enabling the user to select a desired contract format from among plural contract formats, payment relating to the provision of a vehicle or components disposed in the vehicle that reflect an interior finish created in advance by the user can be performed by a method that meets the user's needs.

A server according to a second aspect is the first aspect, in which the plural contract formats include a purchase contract for the vehicle or the component, a subscription contract or a lease contract for the vehicle or the component, and a car rental contract or a car sharing contract for the vehicle.

In the server according to the second aspect, the plural contract formats include a purchase contract for the vehicle or the component, a subscription contract or a lease contract for the vehicle or the component, and a car rental contract or a car sharing contract for the vehicle. This enables the server to present a contract format to a user that meets the use needs of either ownership of a vehicle or a component, long-term lending of a vehicle or a component, or short-term lending of a vehicle.

A server according to a third aspect is the first aspect or the second aspect, further including: a setting unit configured to set remuneration for a provider commissioned to provide, to the user, the vehicle in which the component is disposed in the vehicle cabin space in accordance with the arrangement information acquired by the acquisition unit or the component according to the arrangement information; and a provision unit configured to provide, to the provider, the remuneration set by the setting unit in a case in which the vehicle in which the component is disposed in the vehicle cabin space in accordance with the arrangement information acquired by the acquisition unit or the component according to the arrangement information has been provided to the user.

In the server according to the third aspect, a setting unit sets remuneration for a provider commissioned to provide, to a user, at least one of a vehicle in which a component is disposed in a vehicle cabin space in accordance with arrangement information acquired by the acquisition unit or a component according to the arrangement information. Moreover, in a case in which the vehicle or the component has been provided to the user, a provision unit provides the remuneration set by the setting unit to the provider. As a result, with the server, the provision of vehicles or components to users can be entrusted to a store while also providing remuneration to the store.

A server according to a fourth aspect is the third aspect, in which the setting unit adjusts the remuneration for the provider based on an amount of work performed by the provider in order to dispose the component in the vehicle cabin space in accordance with the arrangement information acquired by the acquisition unit.

In the server of the fourth aspect, the setting unit adjusts the remuneration for the provider in consideration of the amount of work performed by the provider when arranging the components in the vehicle cabin space in accordance with the arrangement information acquired by the acquisition unit. As a result, with the server, it is possible to increase remuneration in cases in which a large amount of work is performed by the provider, or to reduce remuneration in cases in which a small amount of work is performed by the provider.

A server according to a fifth aspect is the third aspect or the fourth aspect, in which the provision unit provides design rules related to a certified product of the component to a supplier, the setting unit sets remuneration for the supplier corresponding to provision, to the user, of the certified product produced by the supplier, and the provision unit provides the remuneration set by the setting unit to the supplier in a case in which the vehicle in which the certified product is disposed in the vehicle cabin space or the certified product has been provided to the user.

In the server of the fifth aspect, the provision unit provides design rules relating to certified products of the components to a supplier. Moreover, the setting unit sets remuneration for the supplier corresponding to provision, to the user, of the certified product produced by the supplier. Moreover, the provision unit provides the remuneration set by the setting unit to the supplier in a case in which the vehicle in which the certified product is disposed in the vehicle cabin space or the certified product has been provided to the user. This enables certified products of the component to be used in the vehicle, and also enables remuneration to be provided to a supplier who manufactures a certified product. [0016] As described above, the server according to the present disclosure enables payment relating to the provision of a vehicle or a component disposed in a vehicle that reflects an interior finish created in advance by a user, to be performed using a method that meets the user's needs.

### BRIEF DESCRIPTION OF THE DRAWINGS

FIG. 1 is a diagram illustrating a schematic configuration of an information processing system.

FIG. 2 is a block diagram illustrating a hardware configuration of a server.

FIG. 3 is a flowchart illustrating a flow of presentation processing performed by a server.

FIG. 4 is a display example of a selection screen displayed on the display section of the user terminal.

FIG. 5 is a flowchart illustrating a flow of first provision processing performed by a server.

FIG. 6 is a flowchart illustrating a flow of second provision processing performed by a server.

### DETAILED DESCRIPTION

Explanation follows regarding an information processing system 10 according to the present embodiment.

An information processing system 10 according to the present embodiment is a system that performs payment, relating to the provision of a vehicle or a component placed in a vehicle that reflects an interior created in advance by a user, by a method that meets the user's usage needs.

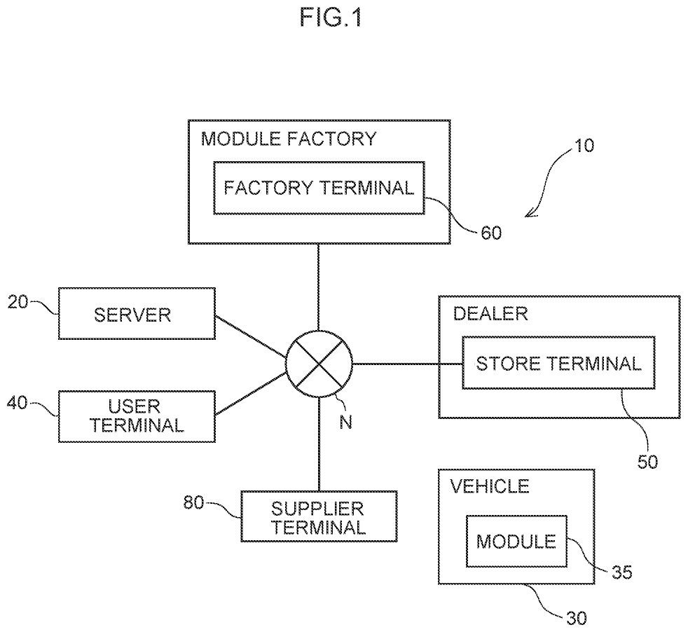

FIG. 1 is a diagram illustrating a schematic configuration of an information processing system 10.

As illustrated in FIG. 1, the information processing system 10 includes a server 20, a vehicle 30, a user terminal 40, a store terminal 50, a factory terminal 60, and a supplier terminal 80. The server 20, the user terminal 40, the store terminal 50, the factory terminal 60, and the supplier terminal 80 are connected through a network N.

The server 20 is a server computer held by a predetermined business operator.

The vehicle 30 is a two-occupant vehicle not provided with a rear seat. The vehicle is capable of creating a vehicle cabin space favorable to the user apart from the seats for travel; namely, by arranging a module 35 such as a sofa, a table, and the like in a cabin space rearward of a driver's seat and a passenger seat.

The module 35 is standardized according to the vehicle 30, and is provided with a fixable section (not illustrated) that is fixable to a fixing section (not illustrated) provided in a vehicle cabin space of the vehicle 30. The module 35 can be disposed in the vehicle 30 by fixing the fixing section of the module 35 to the fixable section of the vehicle 30. Note that the module 35 is detachably fixed to the vehicle 30. The module 35 is an example of a “component”.

The user terminal 40 is a smartphone managed by a user wishing to use the vehicle 30. An application (hereafter referred to as a “generation app”) for configuring the interior of the vehicle 30 is installed in the user terminal 40. With the user terminal 40, it is possible to determine the type, layout, dimensions, and color of the module 35 disposed in the vehicle cabin space of the vehicle 30, as well as to perform selection, for example, of whether or not to use recycled products, described below, through the generation app.

The store terminal 50 is a terminal managed by a dealer that sells the vehicle 30, and that is capable of providing at least one of the vehicle 30 or the module 35 to a user. The dealer is an example of a “supplier”.

The factory terminal 60 is a terminal managed by a module factory including a new factory that produces a genuine module 35, and a recycling factory that causes the module 35 returned from the user to be recycled into a reusable recycled product. As an example, a recycling factory regenerates the module 35 into a reusable recycled product by repairing, cleaning, and the like of the module 35.

The supplier terminal 80 is a terminal managed by a supplier who is authorized to produce a certified product module 35 certified by a business that manages a module factory. As an example, when producing the certified product module 35, the supplier pays a predetermined registration fee to the business operator managing the server 20, whereby the production of the certified product is permitted. Moreover, the server 20 transmits design information indicating a design rule relating to a certified product of the module 35 to the supplier terminal 80 managed by the supplier authorized to produce the certified product, and provides the design rule relating to the certified product to the supplier. This enables the quality of the module 35 to be maintained at a predetermined standard consistent with the genuine module 35, even if the certified product of the module 35 is produced by the supplier.

Note that the store terminal 50, the factory terminal 60, and the supplier terminal 80 are, for example, personal computers (PC).

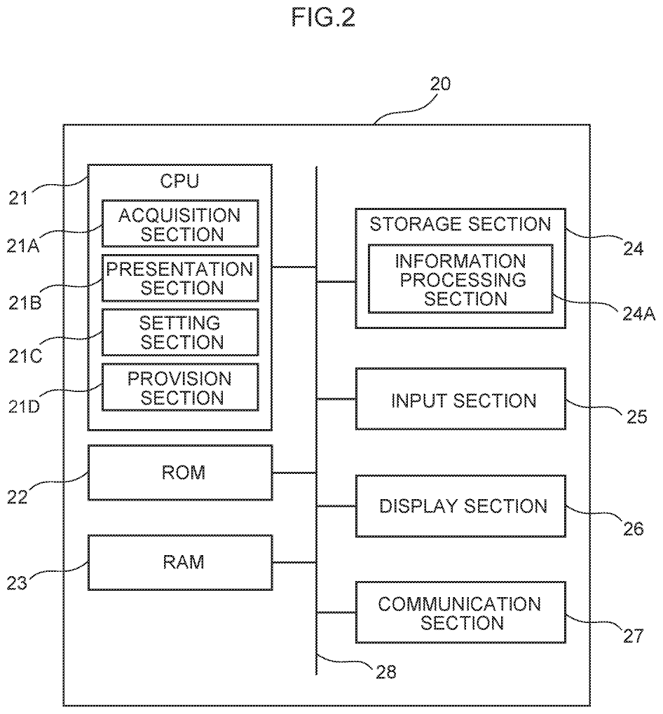

Next, explanation follows regarding a hardware configuration of the server 20. FIG. 2 is a block diagram illustrating a hardware configuration of the server 20.

As illustrated in FIG. 2, the server 20 includes a central processing unit (CPU) 21, read only memory (ROM) 22, random access memory (RAM) 23, a storage section 24, an input section 25, a display section 26, and a communication section 27. These configurations are connected together through a bus 28 so as to be capable of communicating with each other.

The CPU 21 is a central processing unit that executes various programs and controls various sections. Namely, the CPU 21 reads a program from the ROM 22 or the storage section 24, and executes the program using the RAM 23 as a workspace. The CPU 21 controls the respective configurations and performs various computation processing according to a program recorded in the ROM 22 or the storage section 24.

The ROM 22 stores various programs and various data. The RAM 23 serves as a workspace to temporarily store programs and data.

The storage section 24 is configured by a storage device such as a hard disk drive (HDD), a solid state drive (SSD), or flash memory, and holds various programs and various data. The storage section 24 holds an information processing program 24A for causing the CPU 21 to execute presentation processing, first provision processing, and second provision processing, described below.

The input section 25 includes a pointing device such as a mouse, a keyboard, a microphone, a camera, and the like, and is used to perform various inputs.

The display section 26 is, for example, a liquid crystal display, and displays various information. The display section 26 may employ a touch panel method to function as the input section 25.

The communication section 27 is an interface for communicating with other devices. For example, a wired communication standard such as the Ethernet (registered trademark) or FDDI, or a wireless communication standard such as 4G, 5G, Bluetooth (registered trademark), or Wi-Fi (registered trademark) is used for this communication. The communication section 27 is connected to the network N.

Next, explanation follows regarding the functional configuration of the server 20. As illustrated in FIG. 2, the CPU 21 of the server 20 includes an acquisition section 21A, a presentation section 21B, a setting section 21C, and a provision section 21D as functional configuration. The respective functional configuration is implemented by the CPU 21 reading and executing the information processing program 24A stored in the storage section 24.

The acquisition section 21A acquires module information determined by the user and relating to the layout of the modules 35 disposed in the vehicle cabin space of the vehicle 30. The module information is an example of “arrangement information”. Examples of the module information include the type, layout, size, and color of the module 35, the usability of recycled articles, identification information identifying the user, and a usage date and time when the user wishes to use the vehicle 30 or the module 35.

The presentation section 21B presents to the user plural contract formats regarding payment relating to provision of the vehicle 30 in which the module 35 is disposed in the vehicle cabin space according to the module information acquired by the acquisition section 21A, or of the module 35 according to the module information. As an example, in a case in which a predetermined operation has been performed on the generation app by the user terminal 40, a selection screen that enables a desired contract format to be selected from among the plural contract formats is presented to the user terminal 40.

Note that the plural forms of contract described above are purchase agreements for the vehicle 30 or the module 35, subscription agreements or lease agreements for the vehicle or the module 35, and rental car agreements or car share agreements for the vehicle 30. This enables the server 20 to present to the user a contract format that meets the use needs for either the ownership of the vehicle 30 or the module 35, the long-term lending of the vehicle or the module 35, or the short-term lending of the vehicle 30.

The setting section 21C sets remuneration for a dealer who has been commissioned with provision to a user of at least one of the vehicle 30 with the module 35 disposed in the vehicle cabin space according to the module information acquired by the acquisition section 21A or of the module 35 according to the module information. At this time, the setting section 21C adjusts the remuneration for the dealer in consideration of the amount of work performed by the dealer when arranging the module 35 in the vehicle cabin space according to the relevant module information. As an example, in a case in which the number of modules 35 disposed in the vehicle cabin space is three or more, the setting section 21C increases the remuneration for the dealer by a predetermined amount. Moreover, in a case in which the number of modules 35 disposed in the vehicle cabin space is one, the setting section 21C decreases the remuneration for the dealer by a predetermined amount.

Moreover, the setting section 21C sets remuneration for the supplier in response to the provision of the certified product of the module 35 produced by the supplier to the user. As an example, the setting section 21C sets an amount corresponding to the number of certified products of the module 35 provided to the user as remuneration for the supplier. Note that the supplier periodically delivers the certified products of the produced modules 35 to the dealer.

Note that in a case in which a store clerk of the dealer has provided the vehicle 30 or the module 35 to a user, the store clerk inputs provision information relating to the provided vehicle 30 or the module 35 to the store terminal 50. The store terminal 50 causes the input provision information to be stored in a non-illustrated storage section, and periodically transmits the provision information stored in the storage section to the server 20. The server 20 causes the provision information transmitted from the store terminal 50 to be stored in the storage section 24. The server 20 then sets remuneration for the supplier based on the provision information stored in the storage section 24 as a function of the setting section 21C.

The provision section 21D, in cases in which the vehicle 30 with the module 35 disposed in the vehicle cabin space according to the module information or the module 35 according to the module information is provided to the user, provides the remuneration set by the setting section 21C to the dealer. As an example, in a case in which the provision section 21D acquires provision information transmitted from the store terminal 50, the amount equivalent to the remuneration is transferred from the account of the business operator managing the server 20 to the account of the dealer.

Moreover, the provision section 21D transmits design information indicating a design rule relating to a certified product of the module 35 to the supplier terminal 80, and provides the design rule relating to the certified product to the supplier. Moreover, in a case in which the vehicle 30 in which the certified product is disposed in the vehicle cabin space, or the certified product, is provided to the user, the provision section 21D provides the remuneration set by the setting section 21C to the supplier. As an example, in a case in which the provision information transmitted from the store terminal 50 includes an indication that a certified product has been provided, the provision section 21D remits the amount equivalent to the remuneration from the account of the business operator managing the server 20 to the account of the supplier.

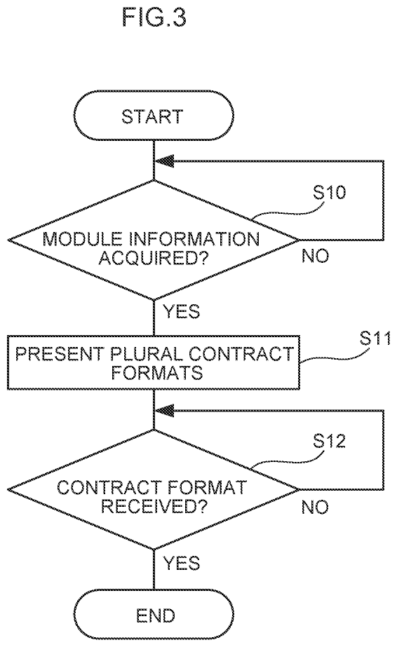

FIG. 3 is a flowchart illustrating a flow of presentation processing in which the server 20 presents to the user plural contract formats regarding payment relating to the provision of the vehicle 30 with the module 35 disposed in the vehicle cabin space according to the module information or the module 35 according to the module information. The presentation processing is performed by the CPU 21 reading, from the storage section 24, the information processing program 24A, and opening and executing the information processing program 24A in the RAM 23.

At step S10 illustrated in FIG. 3, the CPU 21 determines whether or not module information has been acquired from the user terminal 40, and in a case in which it is determined that the module information has been acquired (step S10: YES), the processing proceeds to step S11. On the other hand, in a case in which the CPU 21 determines that the module information has not been acquired (step S10: NO), the CPU 21 waits until the module information is acquired.

At step S11, in response to the module information acquired at step S10, the CPU 21 presents to the user plural contract formats regarding payment relating to provision of the vehicle 30 with the module 35 disposed in the vehicle cabin space or the module 35 according to the module information. In the server 20, by enabling the user to select a desired contract format from among plural contract formats, payment relating to the provision of the vehicle 30 or the module 35 disposed in the vehicle 30 that reflects the interior finish created in advance by the user can be performed by a method corresponding to the user's use needs. The flow then advances to step S12.

At step S12, the CPU 21 determines whether or not the user terminal 40 has accepted the selection of a desired contract format from among plural contract formats through the generation app, and in a case in which it is determined that the selection of the desired contract format has been accepted (step S12: YES), the presentation processing is ended. On the other hand, in cases in which the CPU 21 determines that the selection of the desired contract format has not been accepted (step S12: NO), the CPU 21 waits until the selection of the desired contract format is accepted.

Next, explanation follows regarding an example of a display displayed on the generation app in the presentation processing illustrated in FIG. 3.

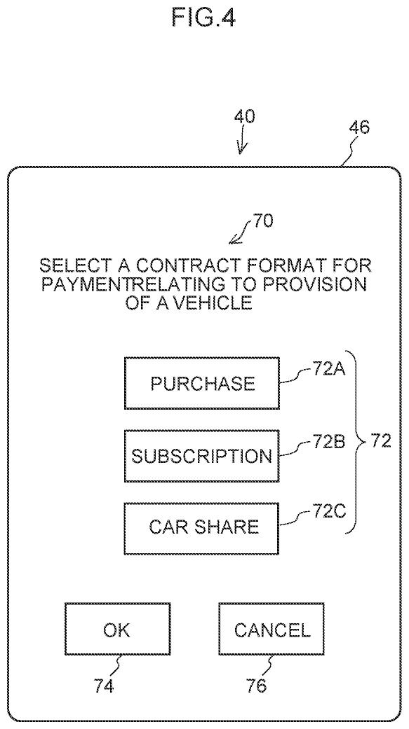

FIG. 4 is a display example of a selection screen displayed on the display section 46 of the user terminal 40. As an example, the selection screen illustrated in FIG. 4 presents plural contract formats relating to payment relating to the provision of the vehicle 30 in which the module 35 is disposed in the vehicle cabin space according to the module information.

The selection screen illustrated in FIG. 4 displays message information 70, a selection button 72, an OK button 74, and a cancel button 76.

The message information 70 indicates various messages to the user. As an example, in FIG. 4, “SELECT A CONTRACT FORMAT FOR PAYMENT RELATING TO PROVISION OF A VEHICLE” is displayed as the message information 70.

The selection button 72 is a button for accepting a user's selection of a desired contract format. In FIG. 4, as the selection button 72, a first selection button 72A that selects a purchase contract for the vehicle 30, a second selection button 72B that selects a subscription contract for the vehicle 30, and a third selection button 72C that selects a car share contract for the vehicle 30 are displayed.

The OK button 74 is a button that, in a case in which any of the selection buttons 72 is operated in a selected state, transmits information indicating a contract format corresponding to the operated selection button 72 to the server 20.

The cancel button 76 is a button for stopping the selection of a desired contract format and transitioning the screen of the display section 46 to a predetermined content.

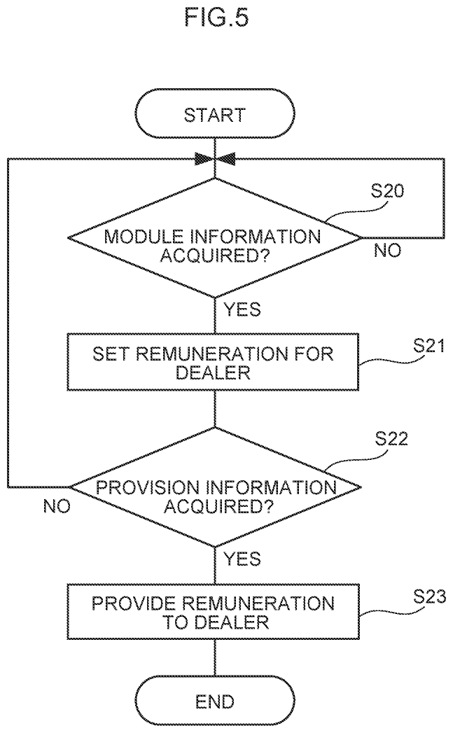

FIG. 5 is a flowchart illustrating a flow of first provision processing performed by the server 20 to provide remuneration to a dealer. The first provision processing is performed by the CPU 21 reading, from the storage section 24, the information processing program 24A, and opening and executing the information processing program 24A in the RAM 23.

At step S20 illustrated in FIG. 5, the CPU 21 determines whether or not module information has been acquired from the user terminal 40, and in a case in which it is determined that the module information has been acquired (step S20: YES), the processing proceeds to step S21. On the other hand, in a case in which the CPU 21 determines that the module information has not been acquired (step S20: NO), the CPU 21 waits until the module information is acquired.

At step S21, the CPU 21 sets remuneration for the dealer based on the module information acquired at step S20. The flow then advances to step S22.

At step S22, the CPU 21 determines whether or not provision information has been acquired from the store terminal 50, and in a case in which it is determined that the provision information has been acquired (step S22: YES), the processing proceeds to step S23. On the other hand, in a case in which the CPU 21 determines that the provision information has not been acquired (step S22: NO), the processing returns to step S20.

At step S23, the CPU 21 provides the remuneration set at step S21 to the dealer. This enables the server 20 to commission the provision of the vehicle 30 or the module 35 to the user while providing remuneration to the dealer. Moreover, the server 20 can increase the remuneration in cases in which the amount of work performed by the dealer is large, or reduce remuneration in cases in which the amount of work performed by the dealer is small. Then, the first provision processing is ended.

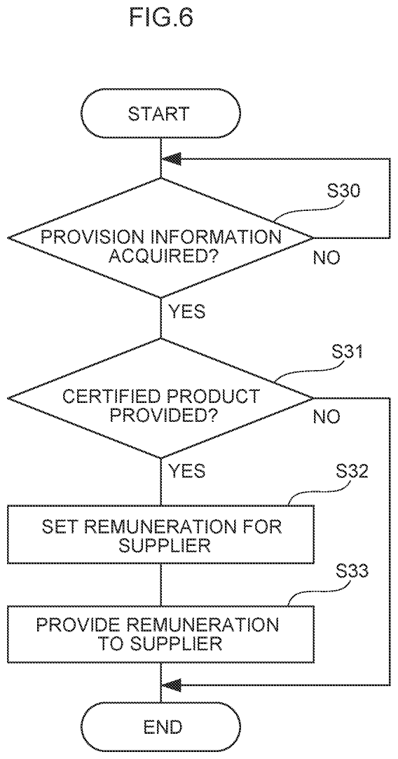

FIG. 6 is a flowchart illustrating a flow of second provision processing performed by the server 20 to provide remuneration to a supplier. The second provision processing is performed by the CPU 21 reading, from the storage section 24, the information processing program 24A, and opening and executing the information processing program 24A in the RAM 23.

At step S30 illustrated in FIG. 6, the CPU 21 determines whether or not provision information has been acquired from the store terminal 50, and in a case in which it is determined that the provision information has been acquired (step S30: YES), the processing proceeds to step S31. On the other hand, in a case in which the CPU 21 determines that the provision information has not been acquired (step S30: NO), the CPU 21 waits until the provision information is acquired.

At step S31, the CPU 21 determines whether or not the provision information acquired at step S30 includes an indication that a certified product has been provided, and in a case in which it is determined that this is included (step S31: YES), the processing proceeds to step S32. On the other hand, in a case in which the CPU 21 determines that the provision information does not include an indication that a certified product has been provided (step S31: NO), the second provision processing is ended.

At step S32, the CPU 21 sets remuneration for the supplier based on the provision information acquired at step S30. The flow then advances to step S33.

At step S33, the CPU 21 provides the remuneration set at step S32 to the supplier. This enables the certified products of the module 35 to be used by the vehicle 30, and remuneration can be provided to the supplier who manufactures the certified goods. Then, the second provision processing is ended.

Other Matters

In the above exemplary embodiments, a dealer who sells the vehicle 30 is an example of a provider. However, there is no limitation thereto, and an example of a provider may be another store such as a rental car store that provides a rental car to a user, or a retail store that sells predetermined merchandise. Note that an example of a provider is not limited to a store, and may be a module factory.

In the above exemplary embodiments, the module 35 can be disposed in a vehicle cabin space rearward of the driver's seat and the passenger's seat of the vehicle 30. However, there is no limitation thereto, and in a vehicle 30 not provided with a passenger seat, the module 35 may be disposed in a vehicle cabin space other than that of the driver's seat.

In the above exemplary embodiments, the contract format of the vehicle 30 and the contract format of the module 35 may differ from each other. For example, the vehicle 30 maybe subject to a purchase agreement and the module 35 may be subject to a subscription agreement.

Although the remuneration for the dealer and the supplier is money in the above exemplary embodiment, there is no limitation thereto, and the remuneration may be in-kind remuneration.

In the above exemplary embodiment, the CPU 21 of the server 20 may present the recommended contract format to the user based on the acquired module information.

Note that the presentation processing, the first provision processing, and the second provision processing executed by the CPU 21 reading and executing software (a program) in the above exemplary embodiments may be executed by various types of processor other than a CPU. Such processors include programmable logic devices (PLD) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The presentation processing, the first provision processing, and the second provision processing may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

Although explanation has been given regarding an aspect in which the information processing program 24A is stored (installed) in advance in the storage section 24 in the above exemplary embodiment, there is no limitation thereto. The information processing program 24A may be provided in a format recorded on a recording medium such as compact disc read-only memory (CD-ROM), digital versatile disc read-only memory (DVD-ROM), or universal serial bus (USB) memory. Alternatively, the information processing program 24A may be provided in a format downloadable from an external device over the network N.

What is claimed is:

1. A server comprising at least one processor, the at least one processor being configured to:
acquire arrangement information related to a layout of a component disposed in a vehicle cabin space other than a seat for travel in a vehicle, the arrangement information being determined by a user wishing to use the vehicle; and
present display, to the user, a plurality of contract formats related to payment for provision of the vehicle in which the component is disposed in the vehicle cabin space in accordance with the arrangement information, or provision of the component according to the arrangement information.

2. The server recited in claim 1, wherein the plurality of contract formats comprise a purchase contract for the vehicle or the component, a subscription contract or a lease contract for the vehicle or the component, and a car rental contract or a car sharing contract for the vehicle.

3. The server recited in claim 1, wherein the at least one processor is further configured to:
set remuneration for a provider commissioned to provide, to the user, the vehicle for which the component is disposed in the vehicle cabin space in accordance with the arrangement information, or the component according to the arrangement information; and
transfer, to the provider, the remuneration in a case in which the vehicle in which the component is disposed in the vehicle cabin space in accordance with the arrangement information, or the component according to the arrangement information, has been provided to the user.

4. The server recited in claim 3, wherein the at least one processor is configured to adjust the remuneration for the provider based on an amount of work performed by the provider in relation to disposing the component in the vehicle cabin space in accordance with the arrangement information.

5. The server recited in claim 3, wherein the at least one processor is configured to:
provide design rules related to a certified product of the component to a supplier,
set remuneration for the supplier corresponding to provision, to the user, of the certified product produced by the supplier, and
transfer the remuneration to the supplier in a case in which the vehicle in which the certified product is disposed in the vehicle cabin space or the certified product has been provided to the user.
